(19) United States
(12) Patent Application Publication
(10) Pub. No.: US 2022/0374845 A1
(43) Pub. Date: Nov. 24, 2022

(54) PREDICT VEHICLE MAINTENANCE BASED ON NAVIGATION ROUTE ROADWAY CHARACTERISTICS

(71) Applicant: INTERNATIONAL BUSINESS MACHINES CORPORATION, Armonk, NY (US)

(72) Inventors: Craig M. Trim, Ventura, CA (US); Sarbajit K. Rakshit, Kolkata (IN); John M. Ganci, JR., Raleigh, NC (US); James E. Bostick, Cedar Park, TX (US); Martin G. Keen, Cary, NC (US)

(21) Appl. No.: 17/323,314

(22) Filed: May 18, 2021

(51) Int. Cl. G06Q 10/00; G06Q 30/02

(52) U.S. Cl. CPC G06Q 10/20; G06Q 30/0283; G06N 20/00

(57) ABSTRACT

Embodiments for a method, computer system, and computer program product for vehicle maintenance prediction are provided. The embodiments may include receiving a course of a vehicle to navigate across a roadway. The embodiments may also include identifying one or more contextual changes as the vehicle navigates across the roadway. The embodiments may further include calculating an impact to vehicle maintenance due to vehicle traversal of the roadway based on the identified contextual changes. The embodiments may also include predicting a value associated with vehicle maintenance based on the calculated impact and the calculated cost.

### BACKGROUND

The present invention relates generally to the field of computing, and more particularly to vehicle maintenance prediction.

A typical cost of vehicle ownership is the need for standard care and maintenance of the vehicle to ensure longevity and reliability. Traditional internal combustion engine vehicles, fully electric vehicles, and hybrid vehicles require certain standards of care in order to maintain the vehicle. However, the type and amount of such care may vary depending on the vehicle type. For example, an internal combustion engine vehicle requires regular oil changes to ensure proper operation of the engine itself otherwise engine failure will ultimately result. Similarly, all vehicles require adequate monitoring of tire pressure and tire wear, which can be affected by environmental temperature, roadway conditions, and vehicle and load weight. With proper monitoring and timely maintenance, a vehicle, regardless of type, can have a greatly extended lifespan and prove reliable when in use.

### SUMMARY

According to one embodiment, a method, computer system, and computer program product for vehicle maintenance prediction is provided. The embodiment may include receiving a course of a vehicle to navigate across a roadway. The embodiment may also include identifying one or more contextual changes as the vehicle navigates across the roadway. The embodiment may further include calculating an impact to vehicle maintenance due to vehicle traversal of the roadway based on the identified contextual changes. The embodiment may also include predicting a value associated with vehicle maintenance based on the calculated impact and the calculated cost.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for vehicle maintenance prediction process according to at least one embodiment.

FIG. 3 is a block diagram of internal and external components of computers and servers depicted in FIG. 1 according to at least one embodiment.

FIG. 4 depicts a cloud computing environment according to an embodiment of the present invention.

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to vehicle maintenance prediction. The following described exemplary embodiments provide a system, method, and program product to, among other things, predict when vehicle maintenance and upgrades may be needed based the characteristics of and conditions along a selected navigation route. Therefore, the present embodiment has the capacity to improve the technical field of vehicle maintenance prediction by reducing, and possibly eliminating, vehicle downtime.

As previously described, a typical cost of vehicle ownership is the need for standard care and maintenance of the vehicle to ensure longevity and reliability. Traditional internal combustion engine vehicles, fully electric vehicles, and hybrid vehicles require certain standards of care in order to maintain the vehicle. However, the type and amount of such care may vary depending on the vehicle type. For example, an internal combustion engine vehicle requires regular oil changes to ensure proper operation of the engine itself otherwise engine failure will ultimately result. Similarly, all vehicles require adequate monitoring of tire pressure and tire wear, which can be affected by environmental temperature, roadway conditions, and vehicle and load weight. With proper monitoring and timely maintenance, a vehicle, regardless of type, can have a greatly extended lifespan and prove reliable when in use. However, determining when proper maintenance is needed and to what extent certain vehicle components have deteriorated based on vehicle usage and roadway conditions may be difficult.

Each roadway a vehicle operates on may present various challenges to vehicle traversal, such as roadway condition, traffic presence, animal presence, obstructions in the roadway, and roadway profile (e.g., steepness, iciness, muddiness, sandiness, height clearance restrictions, narrow lane width). In order to meet each possible challenge, a vehicle may require an appropriate service condition and possibly even one or more technological upgrades to operate under predicted roadway conditions.

Furthermore, each roadway may present different built-in capabilities that an appropriately equipped vehicle may exploit. For example, smart roadways may be fitted with sensors to communicate with a centralized traffic management system or allow for road-based recharging of electric vehicles. If a vehicle does not have the compatible technology necessary to exploit the roadway capability, it may require an upgrade in order to realize a full benefit from the roadway.

Additionally, each roadway segment of a larger travel route may have different roadway conditions that impact various parts, systems, and mechanisms of a vehicle. For examples, an ill-maintained roadway may be riddled with potholes and rough pavement that can increase wear on shocks, struts, suspension systems, and tires. Due to these roadway characteristics, each segment of roadway has a maintenance cost associated with it that can impact an owner or operator's decision to traverse the roadway should the owner or operator be aware of that cost.

In some situations, a centralized management system may be utilized to monitor the status of a vehicle fleet, such as a package delivery company or a service provider requiring on-location work completion. When the centralized management system is determining which vehicles to assign to specific routes, the centralized management system may make the determination based on which vehicles are a best match for the roadway characteristics and conditions. As such, it may be advantageous to, among other things, analyze roadway characteristics and conditions so as to predict future maintenance or upgrades to a vehicle. Additionally, a needs exists for tracking the opportunity cost lost or gained by upgrading a vehicle that would allow for new routes requiring upgraded technologies or capabilities

According to at least one embodiment, changes in vehicle navigation sensor data may be identified based on contextual situations of roadway conditions and vehicle capabilities. Furthermore, the sensor data may be streamed to a centralized management system to determine an appropriate action necessary for other vehicles to safely navigate the contextual situations based on the capabilities of those other vehicles. Additionally, the vehicle maintenance impact and resulting cost for parts and systems usage as a percentage life of the part for navigation across roadways with unique characteristics and conditions derived from the sensor data may also be calculated.

In at least one embodiment, through a centralized management system, the opportunity cost or gain for vehicles not selected to traverse a roadway due to lack of capability as a result of roadway characteristics and conditions may be calculated along with the cost of upgrading vehicles to be capable of encountering such characteristics and conditions.

In another embodiment, the centralized management system may utilize artificial intelligence to determine a compatibility gap in capabilities of a vehicle with the smart road capabilities. The opportunity cost or gain of the upgrade in comparison to potential revenue realized by navigating across the smart roadway may also be calculated.

In yet another embodiment, vehicles may have integrated or communicatively coupled sensors and/or photographic capture devices to stream data of road surface issues, such as potholes or asphalt buckling, to the central management system along with sensor data of the impact such issues incur upon the vehicle navigating across the surface. The artificial intelligence systems of the central management system may be capable of weighting the roadway impacts across 1-n vehicles to determine the maintenance cost to vehicles and determine a priority of repairs to the roadway.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to predict when vehicle maintenance may be needed based on roadway characteristics and conditions experienced by a vehicle traversing specific roadway segments.

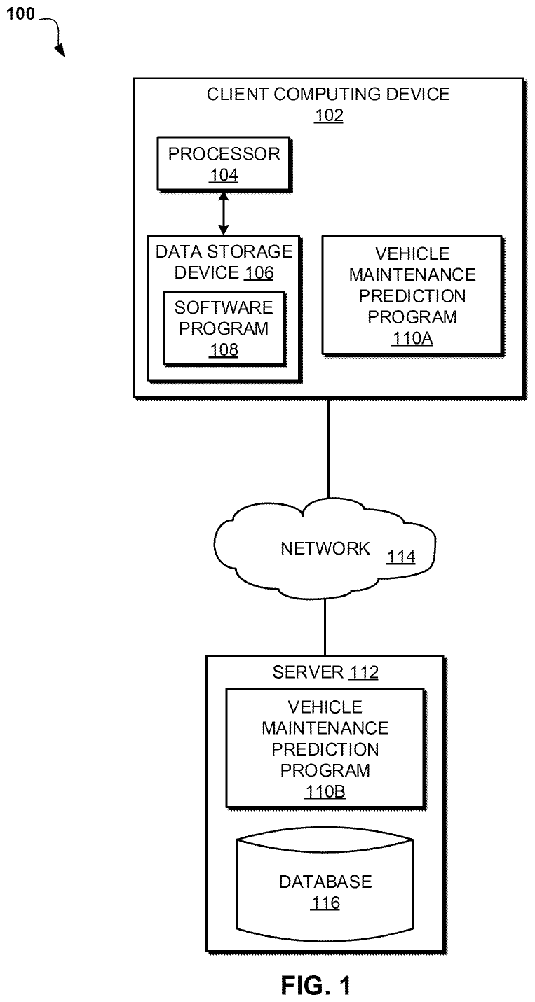

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity. Additionally, in one or more embodiments, the client computing device 102 and a server 112 may each individually host a vehicle maintenance prediction program 110A, 110B. In one or more other embodiments, the vehicle maintenance prediction program 110A, 110B may be partially hosted on both client computing device 102 and server 112 so that functionality may be separated between the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

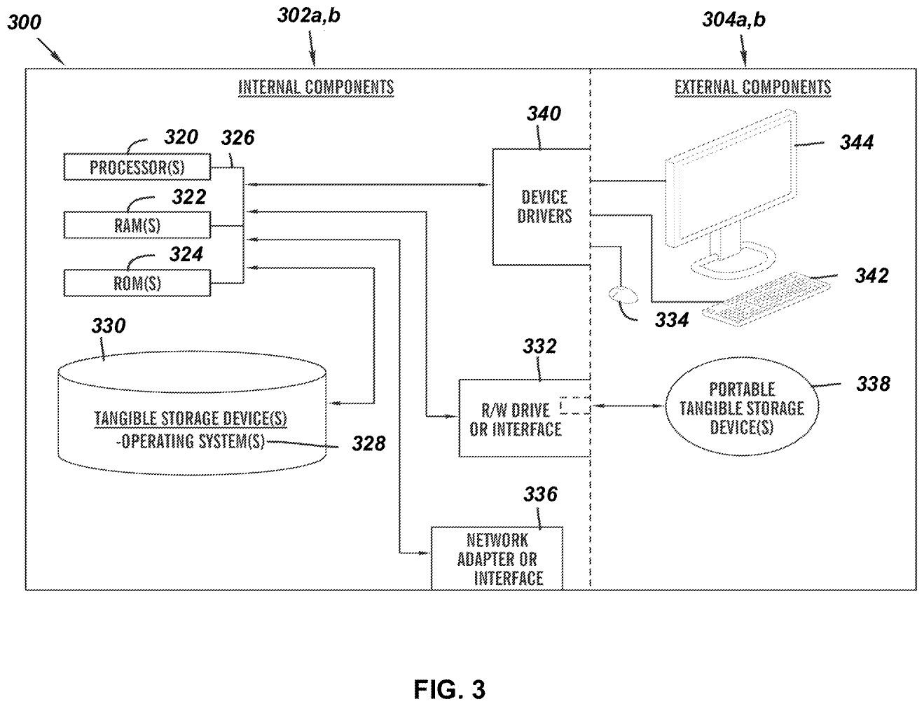

Client computing device 102 may include a processor 104 and a data storage device 106 that is enabled to host and run a software program 108 and a vehicle maintenance prediction program 110A and communicate with the server 112 via the communication network 114, in accordance with one embodiment of the invention. Client computing device 102 may be, for example, an vehicle onboard computing system, an autonomous vehicle, an unmanned aerial vehicle, a mobile device, a telephone, a personal digital assistant, a netbook, a laptop computer, a tablet computer, a desktop computer, or any type of computing device capable of running a program and accessing a network. As previously described, one client computing device 102 is depicted in FIG. 1 for illustrative purposes. However, any number of client computing devices 102 may be utilized in a web conferencing session by individual users or groups of users. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a vehicle maintenance prediction program 110B and a database 116 and communicating with the client computing device 102 via the communication network 114, in accordance with embodiments of the invention. In at least one embodiment, the vehicle maintenance prediction program 110B may be a centralized management system for a vehicle fleet. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

According to the present embodiment, the vehicle maintenance prediction program 110A, 110B may be capable of capturing data of environmental factors associated with a vehicle traversing a roadway and predicting when the vehicle may require either routine or emergency service based on the conditions or characteristics of traversed or soon to be traversed roadways. The sensors capable of capturing the data may be affixed to, externally installed, or internally embedded within the vehicle and may include, but are not limited to, object detection sensors, altimeters, gyroscopes, photographic capture devices, global positioning systems, pressure sensors, fluid level sensors and any other sensor that may be capable of connecting to a network, such as network 114, or capable of transmitting data to a processor, such as processor 104, of a device on which the sensor may be installed. The vehicle maintenance prediction program 110A, 110B may also utilize artificial intelligence technology to analyze the captured environmental factor data and generate a time-based prediction as to when vehicle servicing may be required due to encountered, or soon to be encountered, roadway characteristics and/or conditions. In an least one embodiment, the vehicle maintenance prediction program 110A, 110B may interact with or serve as a vehicle navigation system that prioritizes or favors specific roadway segments when calculating a route from a starting point to a destination point based on the a predicted impact and cost towards vehicle maintenance should a vehicle traverse the roadway segments.

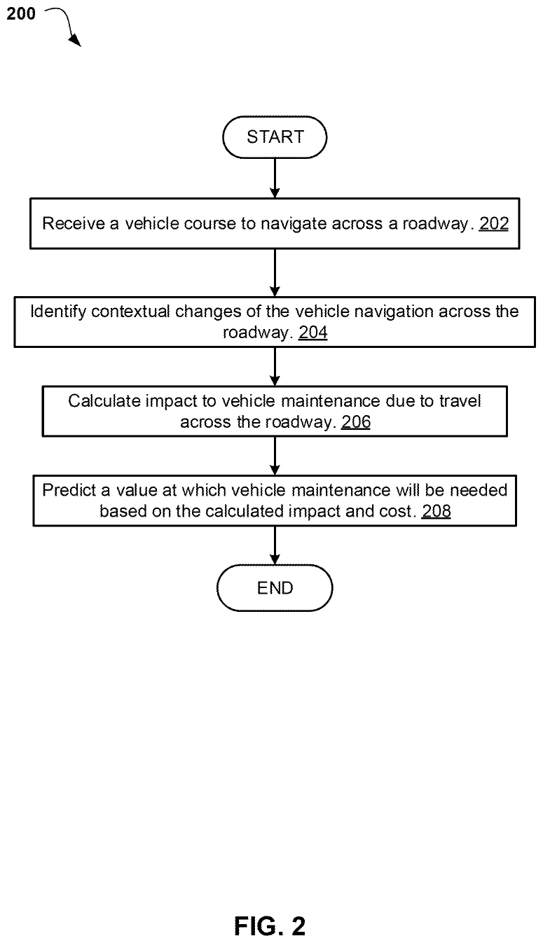

In at least one other embodiment, the vehicle maintenance prediction program 110A, 110B may be capable of identifying when a vehicle is incapable of traversing a roadway based on needed components and roadway characteristics. In at least one other embodiment, the vehicle maintenance prediction program 110A, 110B may be capable of identifying one or more vehicles in a fleet of vehicles best suited for traversal of a roadway based on roadway characteristics and vehicle capabilities and provide a recommendation to a user to utilize the recommended vehicle for traversal of the roadway segment. In yet another embodiment, the vehicle maintenance prediction program 110A, 110B may utilize historical data stored in a centralized management server, such as server 112, of various decisions taken by vehicles to identify required vehicle capabilities and technologies may be required for a vehicle to traverse a roadway. The vehicle maintenance prediction method is explained in further detail below with respect to FIG. 2.

Referring now to FIG. 2, an operational flowchart illustrating a vehicle maintenance prediction process 200 is depicted according to at least one embodiment. At 202, the vehicle maintenance prediction program 110A, 110B receives a vehicle course to navigate across a roadway. The vehicle maintenance prediction program 110A, 110B may receive a destination location from a user. The destination may be received through an onboard vehicle navigation system upon a user inputting a destination either manually or uploading a destination through a third party application, such as Google Maps® (Google Maps and all Google Maps-based trademarks and logos are trademarks or registered trademarks of Google LLC and/or its affiliates). In at least one embodiment, the vehicle maintenance prediction program 110A, 110B may receive the vehicle course during operation and active traversal of a roadway. For example, the vehicle maintenance prediction program 110A, 110B may determine a course change is occurring when a user turns a vehicle from one roadway to another, such as when exiting a highway, changing lanes on a multilane roadway, or turning from one roadway to another.

In at least one embodiment, the vehicle maintenance prediction program 110A, 110B may analyze two or more possible roadway segments when determining a route of traversal from a starting point to a destination point based on the roadway characteristics and the capabilities of a particular vehicle. Each segment may then be ranked based on which segment imposes a lower, or the least, maintenance impact. For example, the vehicle maintenance prediction program 110A, 110B may determine three possible routes exist to a destination for an autonomous vehicle. However, one route traverses a roadway with many potholes and another roadway prohibits the use of autonomous vehicles. Since the vehicle maintenance prediction program 110A, 110B may understand vehicle characteristics when determining a roadway segment for traversal, the vehicle maintenance prediction program 110A, 110B may rank the roadway segment with potholes second and the roadway segment prohibiting autonomous vehicles last. In at least one embodiment, the vehicle maintenance prediction program 110A, 110B may provide a notification as to why a specific roadway segment was not selected for traversal on a graphical user interface, such as a top-down view map of roadways from the starting location to the destination with icons representative of roadway hazards or restrictions pointing to specific segments.

In yet another embodiment, a vehicle characteristic combined with a roadway condition may eliminate the roadway from consideration in determining whether a roadway is traversable. For example, in the previous example, the vehicle maintenance prediction program 110A, 110B may eliminate the roadway that prohibits autonomous vehicles from consideration unless an emergency condition is experienced and traversal across the otherwise prohibited roadway is necessary.

Then, at 204, the vehicle maintenance prediction program 110A, 110B identifies contextual changes of the vehicle navigation across the roadway. The vehicle maintenance prediction program 110A, 110B may identify changes in vehicle navigation based on the contextual situation of ever-changing roadway conditions and various vehicle capabilities. When a change in vehicle navigation is identified, the vehicle maintenance prediction program 110A, 110B may determine that a new contextual situation is being presented. Upon detection of a navigation change, the vehicle maintenance prediction program 110A, 110B may communicate with the central management system to share information about the change in situation. In at least one embodiment where the vehicle maintenance prediction program 110A, 110B is separated between the client device 102 and the server 112, the vehicle maintenance prediction program 110A in the client device 102 may share the information related to the change in situation to the vehicle maintenance prediction program 110B in the server 112, which may process the change itself or communicate the change to the central management system. The shared information may include location of where the new contextual situation is detected, timing of detecting the new contextual situation, time when the execution of the driving decision is completed, the type of contextual situation (e.g., bad road, manually driven vehicle, animal in the road, etc.), success rate of addressing the contextual situation, how confidently the situation can be avoided, vehicle parameters (e.g., max speed, weight of vehicle, turning radius, off road capabilities, etc.), and temporary disturbances caused by other vehicles (e.g., traffic stoppages or slowdowns).

The vehicle maintenance prediction program 110A, 110B may use the historically gathered data, stored either by the vehicle maintenance prediction program 110A, 110B or in the central management system, as training data for an artificial intelligence system to learn and create a knowledge corpus for identification of types of contextual situations that occur at specific locations of a roadway, means of overcoming contextual situations used by various vehicle types (e.g., a high clearance vehicle may navigate over a roadway impediment whereas a low clearance vehicle navigates around the same roadway impediment), time required to respond to various contextual situations, impact of vehicle operational parameters (e.g., clearance of vehicle body from roadway), and required vehicle capabilities for various contextual situations.

Next, at 206, the vehicle maintenance prediction program 110A, 110B calculates the impact to vehicle maintenance due to travel across the roadway. When a specific vehicle type navigates a route with a specific set of characteristics and conditions, the vehicle maintenance prediction program 110A, 110B may gather information from sensors and other mechanisms to determine when specific maintenance tasks may be needed. As previously described, many modern vehicles have communicatively coupled sensors, such as object detection sensors, altimeters, gyroscopes, photographic capture devices, global positioning systems, pressure sensors, and fluid level sensors, capable of capturing various data about vehicle operations on a given roadway under specific conditions. Additional sensors may be specially installed on vehicles to take advantage of functionality imbued to a vehicle by the vehicle maintenance prediction program 110A, 110B, such as impact sensors, tire wear sensors, and distance/clearance sensors on specific vehicle components. The vehicle maintenance prediction program 110A, 110B may interact with the various sensors that gather information the vehicle maintenance prediction program 110A, 110B may utilize when calculating impact, or cost, related to traversal of a roadway. For example, impact sensors may provide valuable information relating to shocks and struts, tire wear sensors or photographic capture devices may provide information on tire wear across a roadway and the abrasiveness impact of the roadway surface on the tires, object detection sensors may provide information related to roadway clearance between a vehicle undercarriage and a roadway obstruction, and temperature sensors throughout a vehicle to provide information on the affects of hot and cold fluctuations on vehicle components. Furthermore, some photographic capture devices may be utilized to identify an object and provide an object distance to a vehicle using image recognition and optical character recognition technologies. For example, an onboard camera may be utilized to determine that an item of debris is in the roadway but, based on the vehicle clearance height, circumnavigation of the debris is not necessary as the object may be driven over without impact or damage.

The vehicle maintenance prediction program 110A, 110B may utilize the sensor data provided and recorded by each component and system to calculate the impact on use of a specific vehicle component or system in terms of a maintenance cycle. For example, the vehicle maintenance prediction program 110A, 110B may determine a travel route has three distinct segments (i.e., road segment 1, road segment 2, and road segment 3). Road segment 1 may be steep downhill for 10 miles, which may impact brake wear and engine wear. Road segment 2 may be bumpy for 20 miles, which may impact shock, strut, and tire wear. Road segment 3 may be flat but with high temperatures, which may result in more strain on the engine.

The vehicle maintenance prediction program 110A, 110B may stream roadway characteristics captured while a vehicle traverses a roadway to the centralized management system. In at least one embodiment, the vehicle maintenance prediction program 110A may transmit the roadway characteristics to the vehicle maintenance prediction program 110B, which may perform as a centralized management system for a fleet of vehicles.

The sensor data collected from 1-n vehicles navigating the roadway may be used to calculate the cost of maintenance as another variable in the selection of a travel route by navigation system. The vehicle maintenance prediction program 110A, 110B may calculate the cost of service for parts and labor of each part and system as defined in a system for a specific type of vehicle or calculated dynamically from a searchable parts inventory, labor time, and rate. For example, the cost of replacing shocks and struts with labor may be calculated as X with the life of the part calculated as Y.

A use case example on usage and maintenance cycle derived from the sensors for brakes may determine the usage of brakes as measured by braking sensors that measure pressure and force applied, the duration of braking, and the number of times brakes are applied may calculate the wear on the brakes. The vehicle maintenance prediction program 110A, 110B may also calculate, based on historical usage across similar roadway segments, an estimated usage and further wear on the brakes when calculating a travel route and whether a specific roadway segment should be traversed. As a similar example, the vehicle maintenance prediction program 110A, 110B may measure tire wear as a function of road surface quality or abrasiveness (e.g., roadway type and condition of roadway surface), user vehicle operation characteristics (e.g., frequency and degree of brake applications, speed of vehicle when taking sharp turns, etc.), and current quality of each tire (e.g., tread height, proper rotation and balancing).

The vehicle maintenance prediction program 110A, 110B may calculate the cost of each travel route on each part's maintenance cycle as a percentage impact on the maintenance cycle. For example, continuing the previous example with three roadway segments, traversal of roadway segment 1 may result in brake impact being calculated as the use of the brakes as observed by the information captured from the onboard sensors over the total life expectancy of the brakes. The total cost may then be calculated as the brake impact for the roadway multiplied by the total cost of new brakes. Similar calculations for shocks and struts across roadway segment 2 and engine coolant or engine replacement across roadway segment 3 may be calculated using corresponding sensors. The vehicle maintenance prediction program 110A, 110B may then calculate a total maintenance cost for traversal across any specific roadway segment or a travel route as a whole by adding the calculated impact of each component. The vehicle maintenance prediction program 110A, 110B, or the centralized management system, may evaluate and take into consideration the calculated maintenance cost to each part individually or the vehicle as a whole (i.e., the sum of the maintenance to all parts combined) when determining different possible travel routes from a starting point to a destination in a navigation system, such as software program 108.

Then, at 208, the vehicle maintenance prediction program 110A, 110B predicts a value at which vehicle maintenance will be needed based on the calculated cost. Based on the calculated the cost, the vehicle maintenance prediction program 110A, 110B may provide a prediction to the user, through a graphical user interface, as to how much useful life remains in a given part. In at least one embodiment, the predicted value may be a distance, such as a mileage or kilometrage, at which service may be required. For example, upon completing a road segment, the vehicle maintenance prediction program 110A, 110B may calculate that the front disc brakes of a vehicle have a 75% useful life remaining. Similarly, in at least one embodiment, the vehicle maintenance prediction program 110A, 110B may also provide a date and/or time prediction as to when the useful life of a system or component may end based on historical driving characteristics and roadway conditions. For example, if vehicle is driven approximately 10,000 miles per year and a set of brake pads has a 30,000 mile average lifespan, the vehicle maintenance prediction program 110A, 110B may determine that a new set of brake pads has an approximate lifespan of three years. However, if the vehicle is often driven on mountainous roadways the brakes may more frequently be engaged for longer amounts of time and at higher pressures. Therefore, for a vehicle with a calculated 50% lifespan remaining on a set of brakes, the vehicle maintenance prediction program 110A, 110B may determine the remaining lifespan is less than one year.

It may be appreciated that FIG. 2 provides only an illustration of one implementation and does not imply any limitations with regard to how different embodiments may be implemented. Many modifications to the depicted environments may be made based on design and implementation requirements. In at least one embodiment, the vehicle maintenance prediction program 110A, 110B may require registration of a vehicle to the centralized management system. Upon registration of a vehicle to the centralized management system associated with the vehicle maintenance prediction program 110A, 110B, the vehicle maintenance prediction program 110A, 110B may receive a vehicle course to navigate across a roadway when the drive, or user, changes a current vehicle course onto a new roadway segment, instructs an autonomous vehicle to begin a course that will traverse a specific roadway segment, or initiate a driving route through an onboard navigation system with global positioning system (GPS) capabilities that traverses a specific roadway segment.

In at least one other embodiment, registration of a vehicle to the centralized management system may include opting-in to providing a data feed of captured sensor data for each component or system of the vehicle applicable to determining vehicle system and component durability, vehicle system and component life span, roadway traversal requirements, roadway characteristics, environmental conditions, and any other maintenance-related metrics applicable to measuring component or system usage and life span.

In yet another embodiment, the vehicle maintenance prediction program 110A, 110B, acting as or communicating via network 114 with a centralized management system, may determine which vehicles in a fleet are appropriate for specific roadway characteristics and conditions based on each vehicle's capabilities. Upon each instance of a travel route being presented for selection of a vehicle, various criteria are considered, such as destination and travel path(s), travel path roadway segment characteristics and conditions, vehicle capabilities required for roadway characteristics and conditions, revenue associated with travel path for an autonomous vehicle, vehicle/type selected for a requested route, vehicle/type not selected with list of missing capabilities. A vehicle fleet may also conduct a cost-benefit analysis to determine which vehicles can be upgraded to overcome capability limitations for a given cost in comparison to possible revenue gain. For example, if a vehicle would require 4×4 capabilities to traverse a roadway after a snowstorm, the vehicle maintenance prediction program 110A, 110B may calculate and compare the cost to install an all-wheel drive system against the lost revenue by not being operable until roadways clear. Similarly, a vehicle may not be able to fully utilize roadway capabilities even if the vehicle is able to traverse the roadway. For example, smart roadways require certain technologies, such as sensors for charging an electric vehicle's batteries. The vehicle maintenance prediction program 110A, 110B may calculate and present to a user the cost, both monetarily and/or temporally, to upgrading or not upgrading the vehicle features.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the vehicle maintenance prediction program 110A in the client computing device 102 and the vehicle maintenance prediction program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the vehicle maintenance prediction program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the vehicle maintenance prediction program 110A in the client computing device 102 and the vehicle maintenance prediction program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the vehicle maintenance prediction program 110A in the client computing device 102 and the vehicle maintenance prediction program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

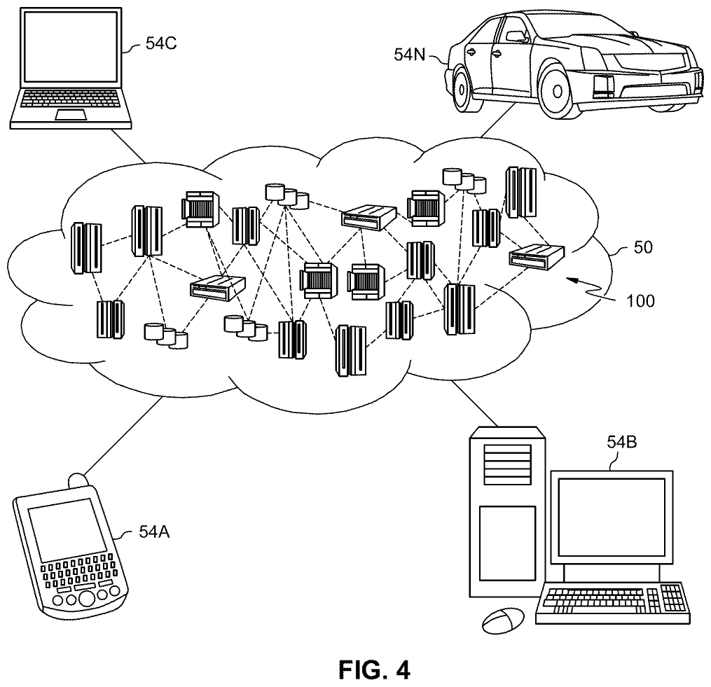

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

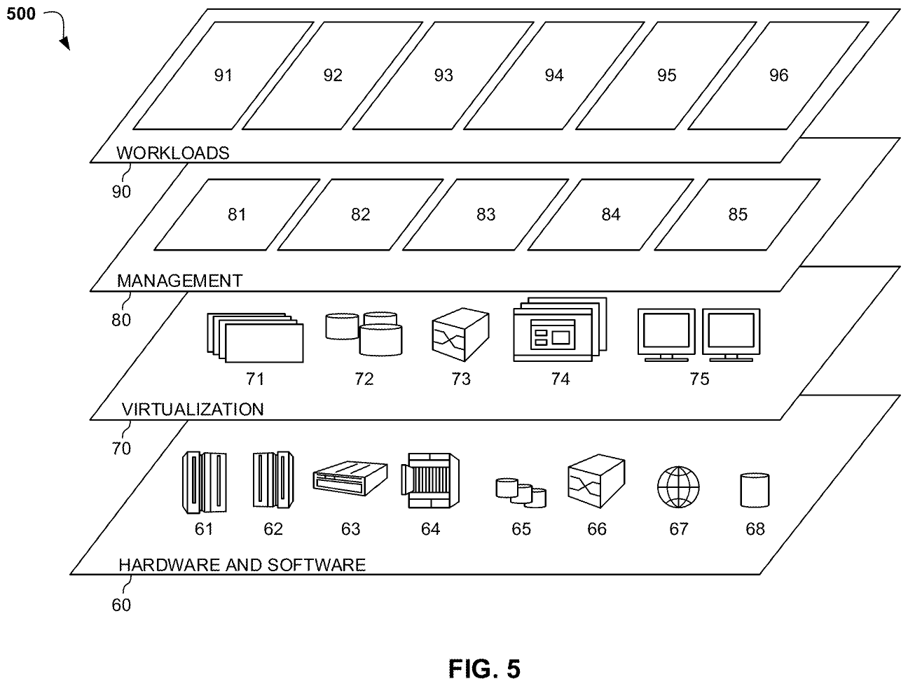

Referring now to FIG. 5, a set of functional abstraction layers 500 provided by cloud computing environment 50 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and vehicle maintenance prediction 96. Vehicle maintenance prediction 96 may relate predicting needed maintenance and upgrades for a vehicle based on navigational route roadway segment characteristics and conditions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
receiving a course of a vehicle to navigate across a roadway;
identifying one or more contextual changes as the vehicle navigates across the roadway;
calculating an impact to vehicle maintenance due to vehicle traversal of the roadway based on the identified contextual changes; and
predicting a value associated with vehicle maintenance based on the calculated impact and the calculated cost.

2. The method of claim 1, wherein the one or more contextual changes relate to roadway conditions, roadway characteristics, and vehicle capabilities.

3. The method of claim 1, wherein the value is a distance at which maintenance will be required.

4. The method of claim 1, wherein the value is a date or time at which maintenance will be required.

5. The method of claim 1, wherein the impact is calculated as use or wear on a specific vehicle component or system in terms of a maintenance cycle.

6. The method of claim 1, further comprising:
registering the vehicle to a centralized management system; and
transmitting a data stream to the centralized management system, wherein data within the data stream is selected from a group consisting of captured sensor data for each component or system of the vehicle applicable to determining vehicle system and component durability, vehicle system and component life span, roadway traversal requirements, roadway characteristics, environmental conditions, and any other maintenance-related metrics applicable to measuring component or system usage and life span.

7. The method of claim 1, further comprising:
determining one or more vehicles in a fleet appropriate for traversal of the roadway based on the one or more identified contextual changes and capabilities of each vehicle in the fleet.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a course of a vehicle to navigate across a roadway;
identifying one or more contextual changes as the vehicle navigates across the roadway;
calculating an impact to vehicle maintenance due to vehicle traversal of the roadway based on the identified contextual changes; and
predicting a value associated with vehicle maintenance based on the calculated impact and the calculated cost.

9. The computer system of claim 8, wherein the one or more contextual changes relate to roadway conditions, roadway characteristics, and vehicle capabilities.

10. The computer system of claim 8, wherein the value is a distance at which maintenance will be required.

11. The computer system of claim 8, wherein the value is a date or time at which maintenance will be required.

12. The computer system of claim 8, wherein the impact is calculated as use or wear on a specific vehicle component or system in terms of a maintenance cycle.

13. The computer system of claim 8, further comprising:
registering the vehicle to a centralized management system; and
transmitting a data stream to the centralized management system, wherein data within the data stream is selected from a group consisting of captured sensor data for each component or system of the vehicle applicable to determining vehicle system and component durability, vehicle system and component life span, roadway traversal requirements, roadway characteristics, environmental conditions, and any other maintenance-related metrics applicable to measuring component or system usage and life span.

14. The computer system of claim 8, further comprising:
determining one or more vehicles in a fleet appropriate for traversal of the roadway based on the one or more identified contextual changes and capabilities of each vehicle in the fleet.

15. A computer program product, the computer program product comprising:
one or more computer-readable tangible storage medium and program instructions stored on at least one of the one or more tangible storage medium, the program instructions executable by a processor capable of performing a method, the method comprising:
receiving a course of a vehicle to navigate across a roadway;
identifying one or more contextual changes as the vehicle navigates across the roadway;
calculating an impact to vehicle maintenance due to vehicle traversal of the roadway based on the identified contextual changes; and
predicting a value associated with vehicle maintenance based on the calculated impact and the calculated cost.

16. The computer program product of claim 15, wherein the one or more contextual changes relate to roadway conditions, roadway characteristics, and vehicle capabilities.

17. The computer program product of claim 15, wherein the value is a distance at which maintenance will be required.

18. The computer program product of claim 15, wherein the value is a date or time at which maintenance will be required.

19. The computer program product of claim 15, wherein the impact is calculated as use or wear on a specific vehicle component or system in terms of a maintenance cycle.

20. The computer program product of claim 15, further comprising:
registering the vehicle to a centralized management system; and
transmitting a data stream to the centralized management system, wherein data within the data stream is selected from a group consisting of captured sensor data for each component or system of the vehicle applicable to determining vehicle system and component durability, vehicle system and component life span, roadway traversal requirements, roadway characteristics, environmental conditions, and any other maintenance-related metrics applicable to measuring component or system usage and life span.
